(19) United States
(12) Patent Application Publication
(10) Pub. No.: US 2016/0187659 A1
(43) Pub. Date: Jun. 30, 2016

(54) Ear-Mounted Display

(71) Applicant: Great Sound Co., Ltd., Taipei City (TW)

(72) Inventor: Yung-Lin Chen, Taipei City (TW)

(21) Appl. No.: 14/961,942

(22) Filed: Dec. 8, 2015

(30) Foreign Application Priority Data
Dec. 25, 2014 (TW) 103145531

(51) Int. Cl. G02B 27/01; G06F 1/16

(52) U.S. Cl. CPC G02B 27/0176; G06F 1/163; G06F 1/1686

(57) ABSTRACT

An ear-mounted display supported by the concha of a user is disclosed. The ear-mounted display has a miniature display, a processor, a support base, and a connecting element. The miniature display is electronically connected with the processor. The support base fits into the concha of the user. The connecting element has a first end and a second end. The first end connects with the miniature display. The second end connects with the support base, whereby the miniature display is situated in front of an eye of the user such that the user can view the miniature display.

### BACKGROUND OF THE INVENTION

1. Field of the Invention

The present invention relates to an ear-mounted display, and more particularly to an ear-mounted display supported by the concha of a user.

2. Description of the Related Art

As electronic devices have developed along with technology, wearable devices have been developed because they are compact and easy to carry. The most noticeable format of wearable devices to date is eyeglasses and watches. However, the eyeglasses format has a complex structure overall, and the materials of the structure add weight to the device. For people who already wear eyeglasses, an additional device in the eyeglasses format is a redundant device, and a period of time may be necessary for users to adjust to a new pair of eyeglasses; therefore, an improvement is needed.

### SUMMARY OF THE INVENTION

It is an object of the present invention to provide an ear-mounted display supported by the concha of a user.

To achieve the abovementioned object, the ear-mounted display has a miniature display, a processor, a support base, and a connecting element. The miniature display is electronically connected with the processor. The support base fits into the concha of the user. The connecting element has a first end and a second end. The first end connects with the miniature display. The second end connects with the support base, whereby the miniature display is situated in front of an eye of the user such that the user can view the miniature display.

### BRIEF DESCRIPTION OF THE DRAWINGS

FIG. 1 is a schematic drawing showing a user wearing the ear-mounted display.

FIG. 2 is a schematic drawing illustrating the ear-mounted display.

FIG. 3 is an exploded perspective view of the ear-mounted display.

FIG. 4 is a schematic drawing of the support base.

FIG. 5 is the hardware structure of the ear-mounted display.

### DETAILED DESCRIPTION OF THE PREFERRED EMBODIMENT

The technical aspects of the invention will become more apparent from the following detailed description of a preferred embodiment.

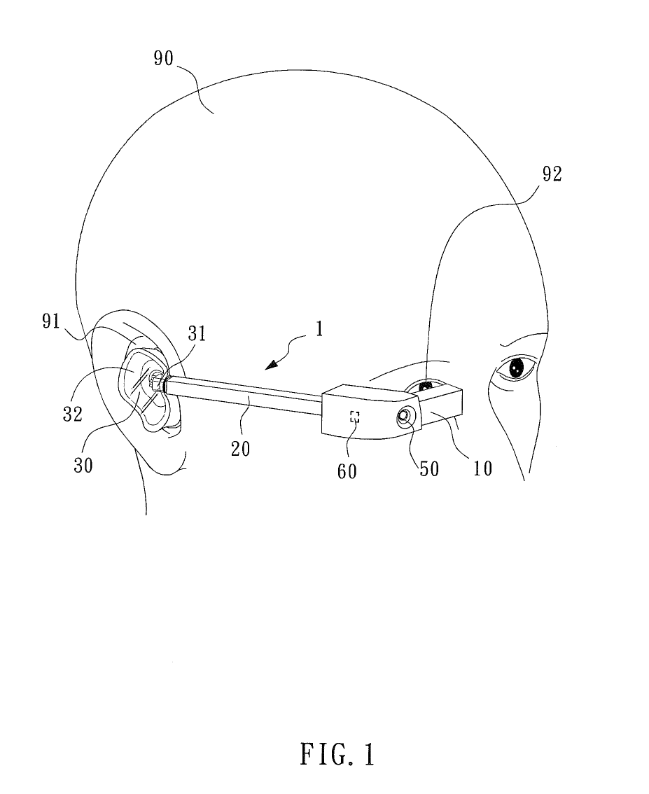

Please refer to FIG. 1 to FIG. 5, which present a schematic drawing showing a user wearing the ear-mounted display, a schematic drawing illustrating the ear-mounted display, an exploded perspective view of the ear-mounted display, a schematic drawing of the support base, and the hardware structure of the ear-mounted display.

As shown in FIG. 1 and FIG. 3, the ear-mounted display 1 in the present embodiment comprises a miniature display 10, a connecting element 20, a support base 30, a camera 50, and a microphone 60, wherein the concha 91 of the user 90 supports the ear-mounted display 1. Therefore, the miniature display 10 is situated in front of and facing an eye 92 of the user 90 such that user 90 can view it. The miniature display 10 can be a liquid crystal display or OLED (organic light emitting diode) display. The camera 50 and the microphone 60 of the present embodiment are both disposed near the miniature display 10.

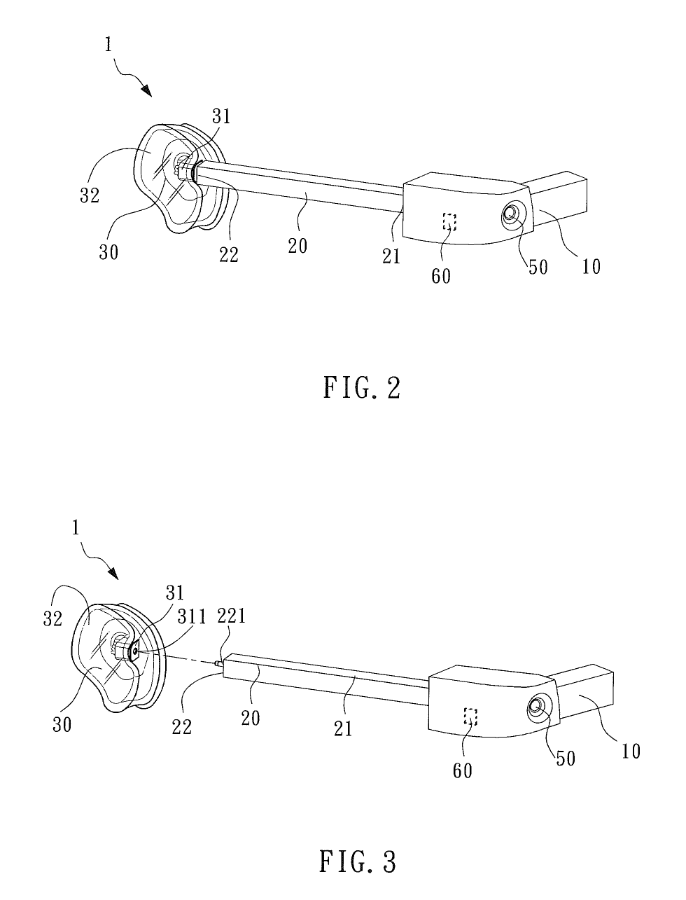

As shown in FIG. 2 and FIG. 3, in the present embodiment, the connecting element 20 is in a bar-shape and its length is roughly equal to but exceeds the distance from the ear to the eye of the user 90. The connecting element 20 comprises a first end 21 and a second end 22, wherein the first end 21 connects with the miniature display 10 and the second end 22 detachably connects with the support base 30. The miniature display 10 is perpendicular to the long axis of the connecting element 20; thus, the end of the ear-mounted display 1, near the eye 92 of the user 90, is in an L shape, and the miniature display 10 faces the eye 92. According to an embodiment of the present invention, as shown in FIG. 3, the second end 22 further comprises a convex point 221 for connecting with the support base 30.

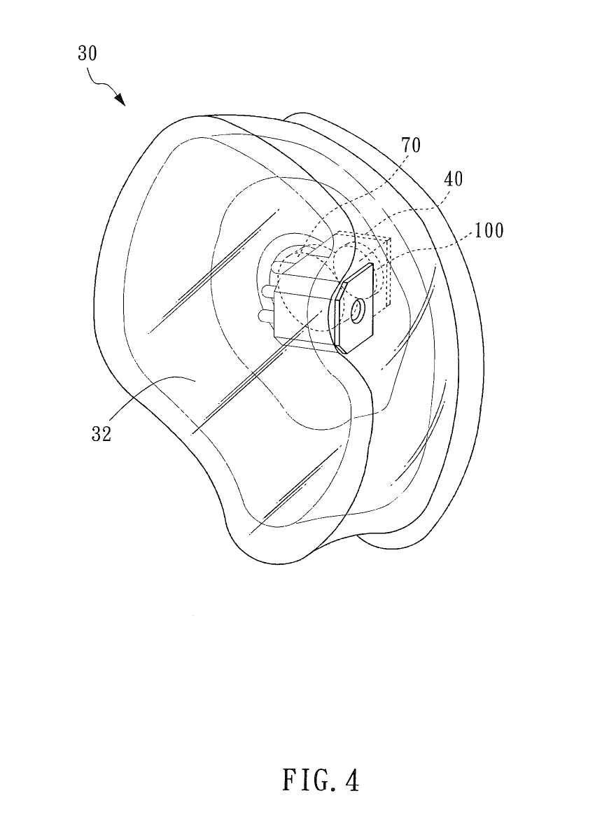

As shown in FIG. 3 and FIG. 4, in the present embodiment, the support base 30 is made of transparent material, and it is in a shape similar to that of a hearing aid such that the ear-mounted display 1 can be placed in and supported by the concha 91 of the user 90. As shown in FIG. 3, the support base 30 comprises a connection portion 31 and an exposed surface 32. The connection portion 31 has a connection hole 311 for connecting with the convex point 221 of the second end 22 such that the connection portion 31 can be detachably connected with the second end 22. It is noted that employing the convex point 221 for engaging with the connection hole 311 is only one embodiment of the present invention and that the present invention is not limited to this embodiment.

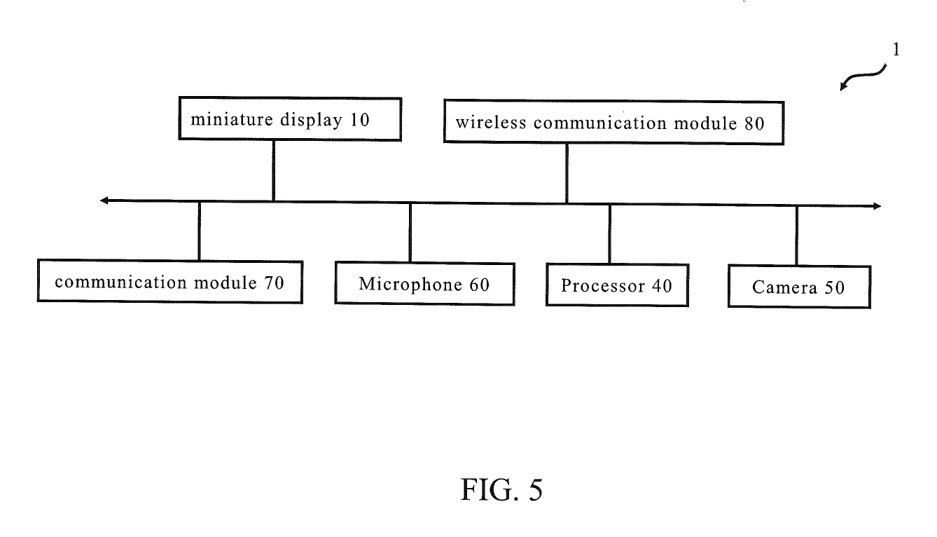

As shown in FIG. 4 and FIG. 5, along with the above-mentioned elements, the ear-mounted display 1 of the present embodiment further comprises a processor 40, a communication module 70, a wireless communication module 80, a power module 100 and a touch module 200 in order to accomplish the operations of the ear-mounted display 1. The processor 40 is electronically connected with the miniature display 10, the camera 50, the microphone 60, the communication module 70, the wireless communication module 80, the power module 100 and the touch module 200. The processor 40 of the ear-mounted display 1 can be disposed in the support base 30, as shown in FIG. 4, or disposed in the connecting element 20. The processor 40 of the present embodiment can be a processor or a processing chip. The elements in the ear-mounted display 1 are powered by the power module 100, and the power module 100 is a battery in the present embodiment. The touch module 200 is disposed on the exposed surface 32. Therefore, by manipulating the touch module 200, the user can manipulate the ear-mounted display 1 via the touch module 200. For example, by manipulating the touch module 200, the user can answer phone calls, initiate the miniature display 10 or adjust the volume of the sound output of the ear-mounted display 1.

The wireless communication module 80 can use Bluetooth or Wi-Fi to establish a signal connection between the ear-mounted display 1 and an electronic device such as a smart phone or a tablet. In the present embodiment, the communication module 70 is disposed in the support base 30; therefore, the support base 30 serves as a blue-tooth earphone that co-operates with the electronic device, and the user can answer phone calls through the microphone 60 and the communication module 70 or transmit information, such as map information or an email notification, to the ear-mounted display 1 and then display the information on the miniature display 10 for the user to view. The communication module 70 of the present embodiment comprises an ear-phone and elements for voice communications; however, because employing a Bluetooth earphone for telephone communication is a well-known technology and the communication module 70 is not the major improvement of the present invention, the related details are omitted. It is noted that the electronic devices that can co-operate with the ear-mounted display 1 are not limited to the present embodiment.

As described above, the objectives, means, and effectiveness of the present invention differ from the characteristics of the prior art. It should be noted that the embodiment described above is for illustrating the principles and effects of the present invention and not for limiting the scope of the present invention. Any person skilled in the art should be able to make modifications and changes to the embodiments without departing from the technical principle and spirit of the present invention. The claims of the present invention within the scope of protection are described below.

What is claimed is:

1. An ear-mounted display, supported by a concha of a user, comprising:
a miniature display;
a processor electronically connected with the miniature display;
a support base fitting into the concha; and
a connecting element comprising a first end and a second end, the first end connecting to the miniature display and the second end connecting to the support base;
whereby the miniature display is located at an eye of the user and is facing the eye such that the user can view the miniature display.

2. The ear-mounted display as claimed in claim 1, further comprising a camera disposed near the miniature display and electronically connected with the processor.

3. The ear-mounted display as claimed in claim 1, further comprising a microphone disposed near the miniature display and electronically connected with the processor.

4. The ear-mounted display as claimed in claim 1, further comprising a communication module disposed in the support base and electronically connected with the processor.

5. The ear-mounted display as claimed in claim 1, wherein the support base detachably connects with the second end.

6. The ear-mounted display as claimed in claim 5, further comprising a camera disposed near the miniature display and electronically connected with the processor.

7. The ear-mounted display as claimed in claim 5, further comprising a microphone disposed near the miniature display and electronically connected with the processor.

8. The ear-mounted display as claimed in claim 1, further comprising a communication module disposed in the support base and electronically connected with the processor.

9. The ear-mounted display as claimed in claim 8, the support base comprising a connection portion, wherein the support base detachably connects with the second end via the connection portion.

10. The ear-mounted display as claimed in claim 9, further comprising a camera disposed near the miniature display and electronically connected with the processor.

11. The ear-mounted display as claimed in claim 9, further comprising a microphone disposed near the miniature display and electronically connected with the processor.

12. The ear-mounted display as claimed in claim 9, further comprising a communication module disposed in the support base and electronically connected with the processor.

13. The ear-mounted display as claimed in claim 1, further comprising a camera disposed near the miniature display and electronically connected with the processor.

14. The ear-mounted display as claimed in claim 13, further comprising a microphone disposed near the miniature display and electronically connected with the processor.

15. The ear-mounted display as claimed in claim 13, further comprising a communication module disposed in the support base and electronically connected with the processor.

16. The ear-mounted display as claimed in claim 15, further comprising a microphone disposed near the miniature display and electronically connected with the processor.

17. The ear-mounted display as claimed in claim 16, further comprising a camera disposed near the miniature display and electronically connected with the processor.
